(19) United States
(12) Patent Application Publication
(10) Pub. No.: US 2013/0235616 A1
(43) Pub. Date: Sep. 12, 2013

(54) EXTERNAL LIGHT SOURCE PROVIDING DEVICE

(71) Applicant: Ta-Chih TANG, Taoyuan County (TW)

(72) Inventor: Ta-Chih TANG, Taoyuan County (TW)

(21) Appl. No.: 13/415,123

(22) Filed: Mar. 8, 2012

(51) Int. Cl. F21L 4/02; F21L 4/00; F21V 8/00

(52) U.S. Cl. 362/611; 362/184; 362/191

(57) ABSTRACT

An external light source providing device comprises a main body, a power supply module, a light-emitting module and a cover. A first and second accommodating spaces are formed on the main body. A mobile electronic device is coupled in the first accommodating space. The power supply module and the light-emitting module are disposed in the second accommodating space. The light-emitting module and the power supply module are electrically connected to each other so that the light-emitting module can be powered by the power supply module to emit light towards the first accommodating space to provide the brightness required by the mobile electronic device. The cover is disposed on the second accommodating space so that the power supply module and the light-emitting module are covered. At least one hole is disposed on the cover so that the light of the light-emitting module can be projected through it.

### BACKGROUND OF THE INVENTION

1. Field of Invention

The present invention relates to an external light source providing device with a simple structure which can provide a light source instantly and conveniently and is suitable for use in mobile electronic devices such as electronic book.

2. Related Art

As technology advances, various portable electronic devices such as MP3 and MP4 multimedia players, mobile phones, personal digital assistants (PDA), handheld video gaming devices, electronic books (E-book), tablet computers, small-sized laptops and laptops are getting more compact and light with advanced functions and have become essential technological tools in everyday life for many modern people. Comparing with desktop computers, portability is one of the main advantages which portable electronic devices have. Portable electronic devices are increasingly being demanded as electronic commerce develops flourishingly. Therefore, portable electronic devices can be seen being used by users very often in the recent years.

Even though electronic book is gradually replacing conventional books made with paper and are preferred by users because of its compactness and can store a large quantity of data. Besides, many readers use electronic book because it can be read online at any moment. However, most electronic books are not provided with a light source and have to reply on other light sources such as natural light or indoors lighting so as to allow the readers to be able to read with enough light. Therefore, an external light source providing device with a simple structure which is convenient to use and can provide a light source instantly is provided by the present invention to meet the requirement.

### SUMMARY OF THE INVENTION

A primary object of the present invention is to provide an external light source providing device with a simple structure which is convenient to use and can provide a light source instantly.

In order to achieve the above-mentioned objects, an external light source providing device of the present invention can be coupled with a mobile electronic device for providing a light source required by the mobile electronic device. The external light source providing device comprises a main body, a power supply module, a light-emitting module and a cover. A first accommodating space and a second accommodating space are formed on the main body, and the first accommodating space and the second accommodating space are disposed side by side on the main body. The mobile electronic device can be coupled on the first accommodating space. The power supply module is disposed in the second accommodating space. The light-emitting module is also disposed in the second accommodating space and is electrically connected to the power supply module so that the light-emitting module can be powered by the power supply module to emit light towards the first accommodating space to provide the brightness required by the mobile electronic device coupled on the first accommodating space. The cover is disposed on the second accommodating space so that the power supply module and the light-emitting module are covered inside the cover. At least one hole is disposed on the cover so that the light of the light-emitting module can be projected through it.

In implementation, the light-emitting module comprises at least one LED light.

In implementation, further comprises a transparent light guiding plate for coupling on the first accommodating space and covering the mobile electronic device entirely. An end of the light guiding plate is facing the hole on the cover so that the light projected outwardly by the light-emitting module through the hole can be guided evenly to the surrounding via the end of the light guiding plate. The transparent light guiding plate has a front end and a back end with the front end facing the hole of the cover and the thickness of the light guiding plate is decreased gradually from the front end to back end.

In implementation, the mobile electronic device is an electronic book.

In implementation, the power supply module comprises a switch.

The present invention will become more fully understood by reference to the following detailed description thereof when read in conjunction with the attached drawings.

### BRIEF DESCRIPTION OF THE DRAWINGS

FIG. 1 is a perspective exploded view of an external light source providing device of an embodiment of the present invention;

FIG. 2 is a perspective exploded view of a light guiding plate and a main body of the embodiment of the present invention before they are coupled together;

FIG. 3 is a perspective view of the light guiding plate and the main body of the embodiment of the present invention after they are coupled together;

FIG. 4 is a perspective view of a mobile electronic device and the main body of the embodiment of the present invention before they are coupled together;

FIG. 5 is a perspective view of the mobile electronic device and the main body of the embodiment of the present invention after they are coupled together; and

FIG. 6 is a perspective view of the mobile electronic device being disposed between the light guiding plate and the main body of the embodiment of the present invention.

### DETAILED DESCRIPTION OF THE INVENTION

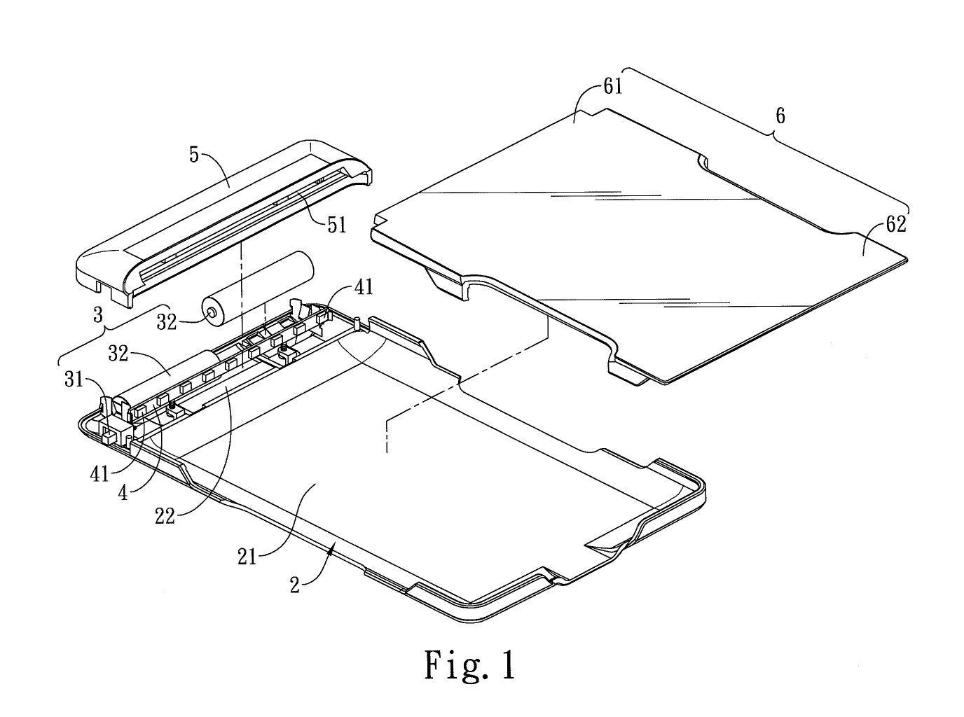

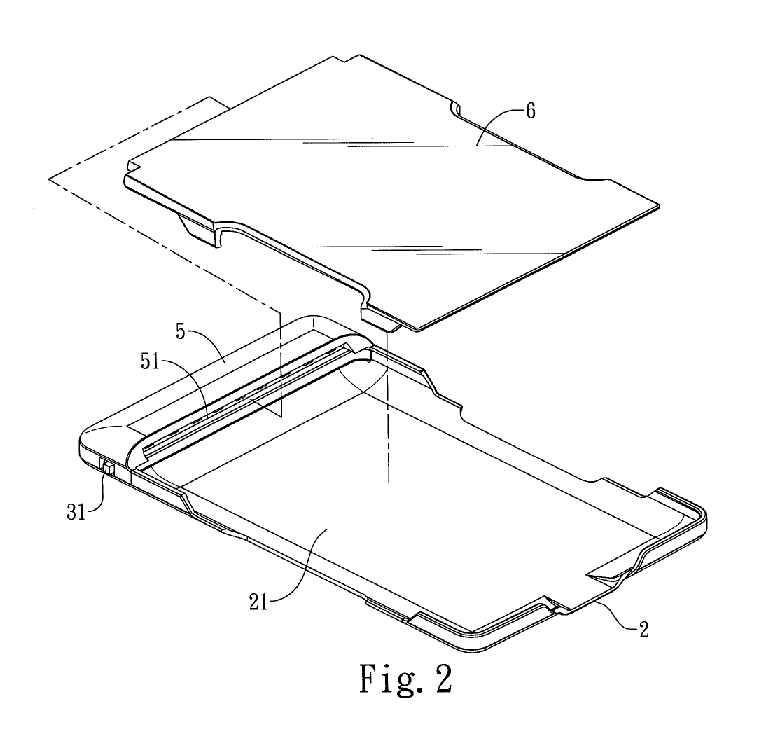

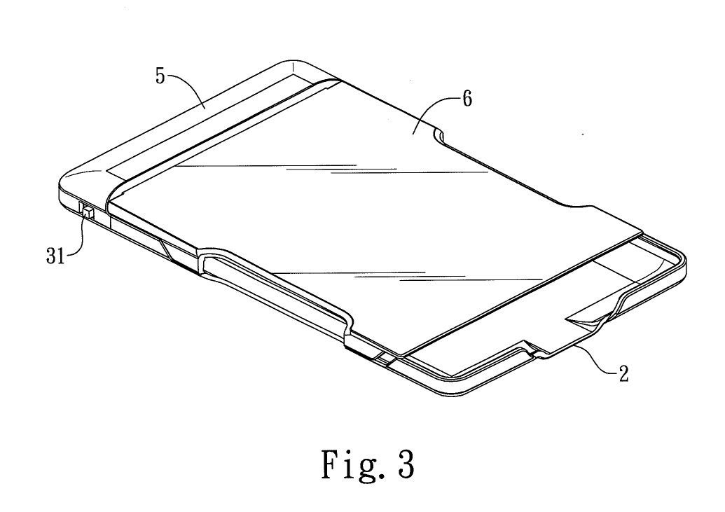

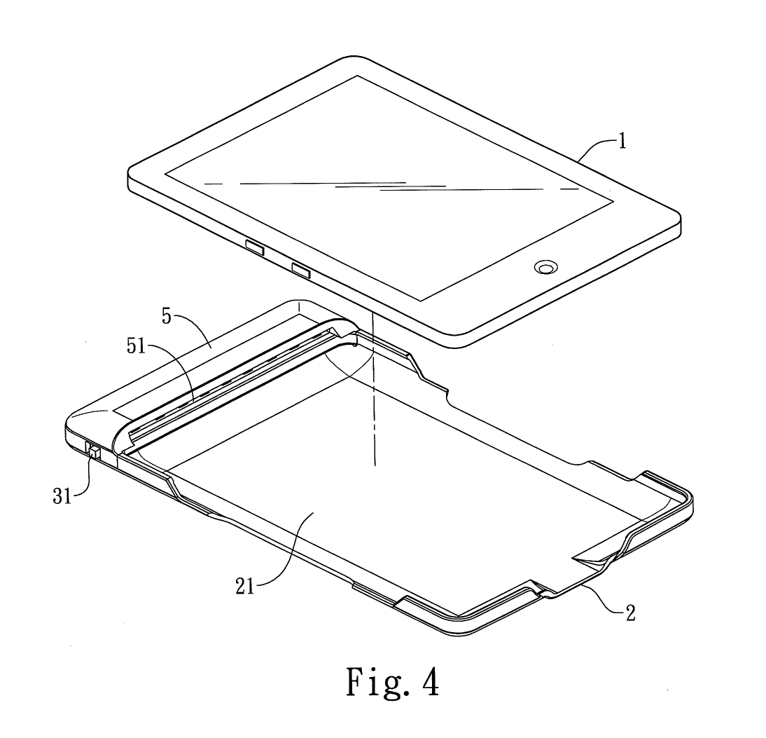

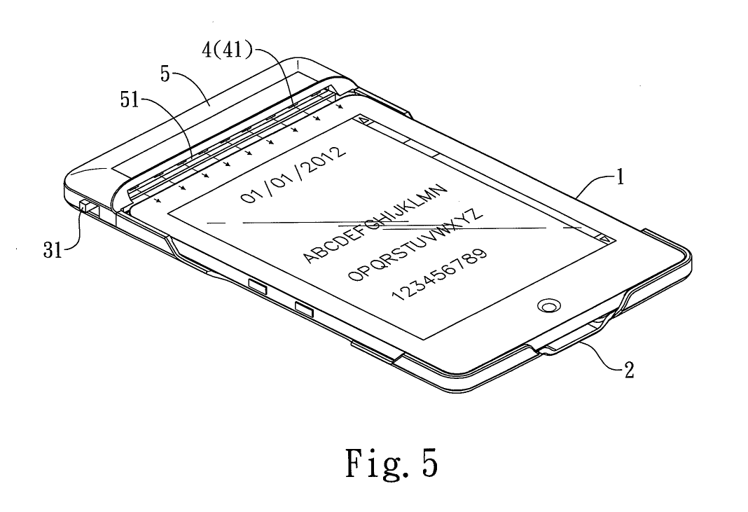

FIGS. 1 to 6 show an embodiment of an external light source providing device of the present invention which can be coupled with a mobile electronic device 1 (such as an electronic book) for providing a light source required by the mobile electronic device 1. The external light source providing device comprises a main body 2, a power supply module 3, a light-emitting module 4, a cover 5 and a transparent light guiding plate 6.

A first accommodating space 21 and a second accommodating space 22 are formed on the main body 2, and the first accommodating space 21 and the second accommodating space 22 are disposed side by side on the main body 2. The mobile electronic device 1 can be coupled on the first accommodating space 21.

The power supply module 3 is disposed in the second accommodating space 22 and it has a switch 31.

The light-emitting module 4 is disposed in the second accommodating space 22 and it comprises at least one LED light 41 and is electrically connected to the power supply module 3 so that the light-emitting module 4 can be powered by the power supply module 3 through a battery 32 or other means to emit light towards the first accommodating space 21 to provide the brightness required by the mobile electronic device 1 coupled on the first accommodating space 21.

The cover 5 is disposed on the second accommodating space 22 so that the power supply module 3 and the light-emitting module 4 are covered inside the cover 5. At least one hole 51 is disposed on the cover 5 so that the light of the light-emitting module 4 can be projected through it.

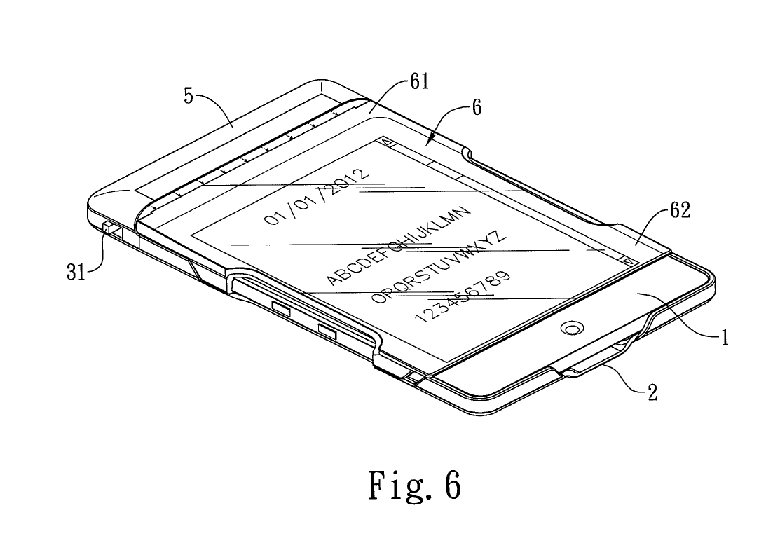

The transparent light guiding plate 6 is coupled on the first accommodating space 21 and is covered on the mobile electronic device 1 entirely as shown in FIG. 6. An end of the light guiding plate 6 is facing the hole 51 on the cover 5 so that the light projected outwardly by the light-emitting module 4 through the hole 51 can be guided evenly to the surrounding via the end of the light guiding plate 6. The transparent light guiding plate 6 has a front end 61 and a back end 62 with the front end 61 facing the hole 51 of the cover 5 and the thickness of the light guiding plate 6 is decreased gradually from the front end 61 to back end 62.

Therefore, in implementation, after the mobile electronic device 1 (e.g. electronic book) is coupled on the first accommodating space 21 of the main body 2 and the switch 31 of the power supply module 3 is switched on, the light-emitting module 4 can be powered by the power supply module 3 to emit light towards the first accommodating space 21 to provide the brightness required by the mobile electronic device 1. After the transparent light guiding plate 6 is coupled on the first accommodating space 21 and is covered on the mobile electronic device 1 entirely, the light of the light-emitting module 4 can be guided evenly to the surrounding via one of the ends of the light guiding plate 6.

Thereby, the main body 2 of the present invention is provided for the mobile electronic device 1 to couple on top and is also used as a protective case for the protection of the mobile electronic device 1. The light source required for the illumination of the mobile electronic device 1 is provided by the power supply module 3 and the light-emitting module 4 on the main body 2 so that the users can read or browse the mobile electronic device 1 anytime and anywhere. The light guiding plate 6 of the present invention allows the light source to be distributed evenly on the surface of the mobile electronic device 1.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An external light source providing device capable of being coupled with a mobile electronic device for providing a light source required by the mobile electronic device; the external light source providing device comprising:
a main body, on which a first accommodating space and a second accommodating space are formed, wherein the first accommodating space and the second accommodating space are disposed side by side on the main body, and the first accommodating space is provided for the mobile electronic device to be coupled therein;
a power supply module, disposed in the second accommodating space;
a light-emitting module, disposed in the second accommodating space and electrically connected to the power supply module so that the light-emitting module is capable of being powered by the power supply module to emit light towards the first accommodating space to provide the brightness required by the mobile electronic device coupled in the first accommodating space; and
a cover, disposed on the second accommodating space so that the power supply module and the light-emitting module are covered inside the cover, and is provided with at least one hole thereon so that the light of the light-emitting module is projected through it.

2. The external light source providing device as claimed in claim 1, wherein the light-emitting module comprises at least one LED light.

3. The external light source providing device as claimed in claim 1, further comprising a transparent light guiding plate that is coupled on the first accommodating space and covers the mobile electronic device entirely, and has an end facing the hole on the cover so that the light projected outwardly by the light-emitting module through the hole is guided evenly to the surrounding via the end of the light guiding plate.

4. The external light source providing device as claimed in claim 3, wherein the transparent light guiding plate has a front end and a back end; the front end faces the hole of the cover; and the thickness of the light guiding plate is decreased gradually from the front end to back end.

5. The external light source providing device as claimed in claim 1, wherein the mobile electronic device is an electronic book.

6. The external light source providing device as claimed in claim 1, wherein the power supply module comprises a switch.
